(19) United States
(12) Patent Application Publication
(10) Pub. No.: US 2015/0325236 A1
(43) Pub. Date: Nov. 12, 2015

(54) CONTEXT SPECIFIC LANGUAGE MODEL SCALE FACTORS

(71) Applicant: MICROSOFT CORPORATION, Redmond, WA (US)

(72) Inventors: MICHAEL LEVIT, San Jose, CA (US); SHUANGYU CHANG, Fremont, CA (US); ZHIHENG HUANG, Sunnyvale, CA (US)

(73) Assignee: MICROSOFT CORPORATION, Redmond, WA (US)

(21) Appl. No.: 14/273,100

(22) Filed: May 8, 2014

(51) Int. Cl. G10L 15/18; G10L 15/14; G10L 15/06

(52) U.S. Cl. CPC G10L 15/18; G10L 15/063; G10L 15/14

(57) ABSTRACT

The customization of recognition of speech utilizing context-specific language model scale factors is provided. Training audio may be received from a source in a training phase. The received training audio may be recognized utilizing acoustic and language models being combined utilizing static scale factors. A comparison may then be made of the recognition results to a transcription of the training audio. The recognition results may include one or more hypotheses for recognizing speech. Context specific scale factors may then be generated based on the comparison. The context specific scale factors may then be applied for use in the speech recognition of audio signals in an application phase.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Many computing devices, such as smartphones, desktops, laptops, tablets, game consoles, and the like, utilize language models in conjunction with acoustic models for performing various automatic speech recognition (ASR) search functions. In an attempt to balance the relative contributions of the aforementioned models, current ASR applications typically apply a fixed weighting factor to language model probabilities. The aforementioned fixed factor (which may be pre-optimized) is kept constant throughout the decoding of associated speech during recognition. Drawbacks associated with the use of fixed weighting factors include the possibility of poor recognition results in some speech recognition contexts. For example, acoustic models may be heavily weighted in situations where recognition is based on how a word sounds to a speaker (e.g., sounds like “table”) while language models may be heavily weighted in situations where recognition is based on surrounding terms in an utterance (e.g., “Lord of the ______”). It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide for the recognition of speech utilizing context-specific language model scale factors. Training audio may be received from a source in a training phase. The received training audio may be recognized utilizing acoustic and language models, the acoustic and language models being combined utilizing static scale factors. A comparison may then be made of the recognition results to a transcription of the training audio. The recognition results may include one or more hypotheses for recognizing speech. Context specific scale factors may then be generated based on the comparison. The context specific scale factors may then be applied for use in the speech recognition of audio signals in an application phase.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a system which may be utilized for the recognition of speech utilizing context-specific language model scale factors, in accordance with an embodiment;

FIG. 2 is a block diagram illustrating a system which may be utilized for generating context specific scale factors for use in a training phase in the system of FIG. 1, in accordance with an embodiment;

FIG. 3 is a block diagram illustrating a system which may utilize context specific scale factors in an application phase in the system of FIG. 1, in accordance with an embodiment;

FIG. 4 is a flow diagram illustrating a routine for generating context specific scale factors for use in a training phase of a speech recognition system, in accordance with an embodiment;

FIG. 5 is a flow diagram illustrating a routine for recognizing speech utilizing context-specific language model scale factors in an application phase of a speech recognition system, in accordance with an embodiment;

FIG. 6 is a simplified block diagram of a computing device with which various embodiments may be practiced;

FIG. 7A is a simplified block diagram of a mobile computing device with which various embodiments may be practiced;

FIG. 7B is a simplified block diagram of a mobile computing device with which various embodiments may be practiced; and

FIG. 8 is a simplified block diagram of a distributed computing system in which various embodiments may be practiced.

### DETAILED DESCRIPTION

Embodiments provide for the recognition of speech utilizing context-specific language model scale factors. Training audio may be received from a source in a training phase. The received training audio may be recognized utilizing acoustic and language models, the acoustic and language models being combined utilizing static scale factors. A comparison may then be made of the recognition results to a transcription of the training audio. The recognition results may include one or more hypotheses for recognizing speech. Context specific scale factors may then be generated based on the comparison. The context specific scale factors may then be applied for use in the speech recognition of audio signals in an application phase.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

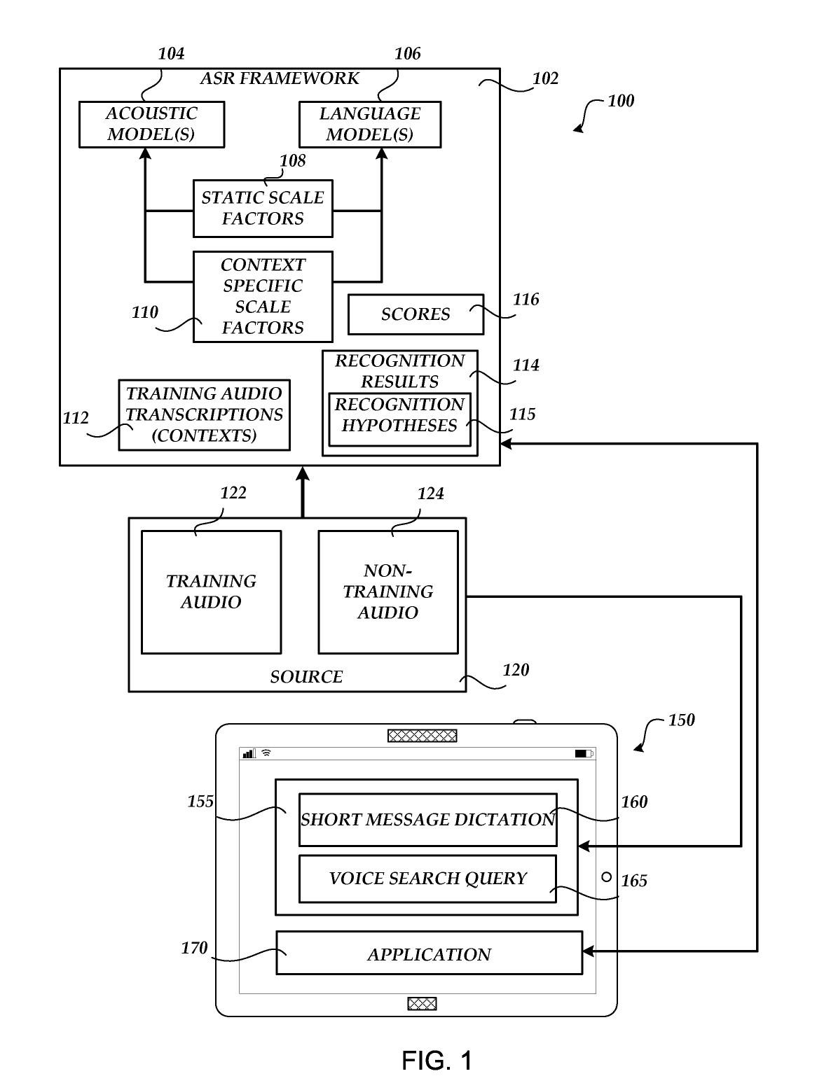

Referring now to the drawings, in which like numerals represent like elements through the several figures, various aspects of the present invention will be described. FIG. 1 is a block diagram illustrating a system 100 which may be utilized for the recognition of speech utilizing context-specific language model scale factors, in accordance with an embodiment. The system 100 (which may comprise an automatic speech recognition (ASR) system) may include ASR framework 102 and a computing device 150 configured to receive training audio 122 and non-training audio 124 from a source 120 (i.e., a speaker).

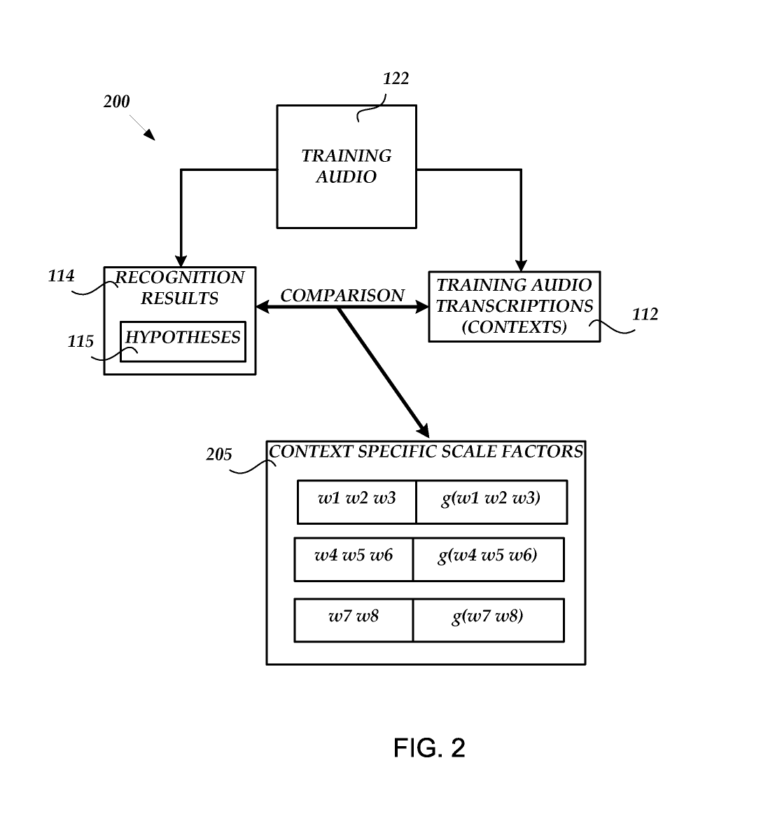

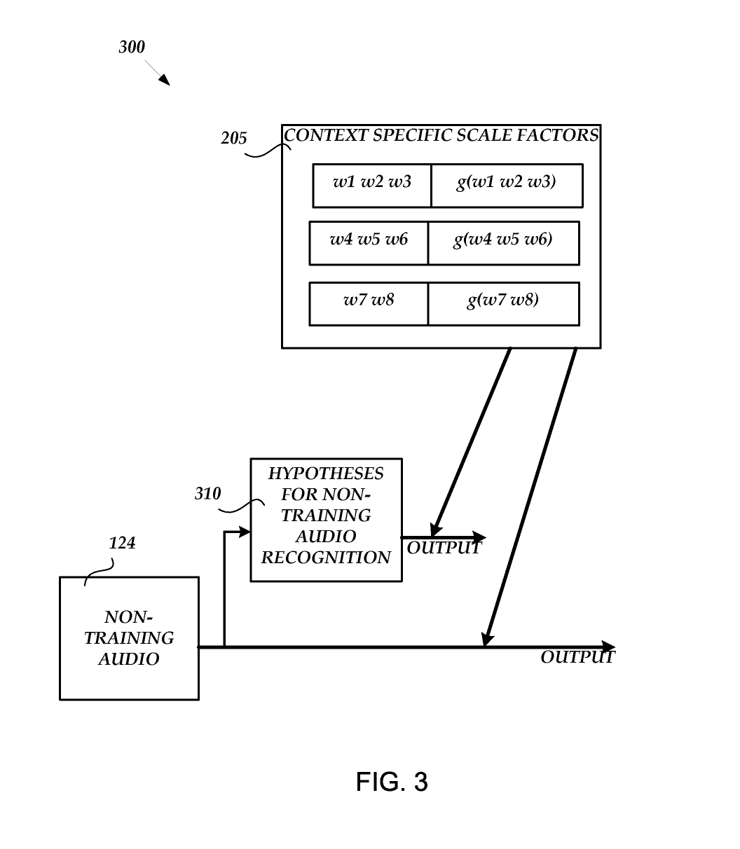

In accordance with various embodiments, the computing device 150 may comprise, without limitation, a desktop computer, laptop computer, smartphone, video game console or a television. The computing device 150 may also comprise or be in communication with one or more recording devices (not shown) used to detect speech and receive video/pictures (e.g., MICROSOFT KINECT, microphone(s), and the like). The computing device 150 may store the application 170 which may be configured to receive the training audio 22 and the non-training audio 124 from the source 120 for providing ASR functions such as short message dictation 160 and voice search query 165 (which may be displayed in a user interface 155 generated by the application 170). As will be described in greater detail below with respect to FIGS. 2-3, the application 170 may further be configured to generate the ASR framework 102 which may be utilized for speech recognition context-specific language model scale factors 110. In accordance with an embodiment, the application 170 may comprise an ASR application such as the BING VOICE SEARCH, WINDOWS PHONE SHORT MESSAGE DICTATION and XBOX MARKET PLACE VOICE SEARCH applications from MICROSOFT CORPORATION of Redmond Wash. It should be understood, however, that other applications (including operating systems) from other manufacturers may alternatively be utilized in accordance with the various embodiments described herein.

The ASR framework 102 may comprise one or more acoustic models 104, one or more language models 106, static scale factors 108, the context specific scale factors 110, training audio transcriptions 112, recognition results 114 and scores 116. With respect to the context specific scale factors 110, it should be understood by those skilled in the art that speech recognition may be described by the following formula:

$${W}^{*} := {arg max}_{w} ( {\sum }_{i} log P ( {a}_{i} \vert {w}_{i} ) + γ log P ( {w}_{i} \vert {w}_{i - 1} … {w}_{i - n + 1} ) )$$

where “W” represents alternative speech recognition hypotheses and the scale factor γ determines how much weight contributions from a language model will be given relative to contributions from an acoustic model. Thus, it should be understood that in the equation above, the scale factor γ remains constant. As will be described in greater detail below with respect to FIGS. 2-3, embodiments may modify the above equation so that the scale factor γ is no longer constant but dependent on previously recognized words. Thus, if a previous recognition includes the partial phrase “I would like to . . . ” and the next word in the phrase is about to be recognized, then the context-specific scale factor γ (“I'd like to”) may be used to do so, rather than a fixed, context-independent scale factor γ. The following formula (which will be described in greater detail below with respect to FIG. 3, demonstrates the use of the aforementioned context-specific scale factor:

$${W}^{*} := {arg max}_{w} ( {\sum }_{i} log P ( {a}_{i} \vert {w}_{i} ) + γ ( {w}_{i - 1} … {w}_{i - n + 1} ) log P ( {w}_{i} \vert {w}_{i - 1} … {w}_{i - n + 1} ) ) .$$

The application 170 may be configured to receive and recognize the training audio 122 utilizing acoustic and language models 104 and 106. The acoustic and language models 104 and 106 may be combined utilizing the static scale factors 108. The application 170 may further be configured for use in a training phase and an application phase.

It should be understood that in the training phase, for each received audio signal (e.g., training audio), a list of alternative recognition results (obtained using a static scale factor) may be sorted by their respective scores (the scores having been computed as evidenced by the expression inside ( . . . ) of the first formula discussed above). Then, while keeping the probability (P) numbers in the formula untouched, the scale factors γ may be uncoupled making them dependent on previous words in a corresponding hypothesis. Then, the context-specific γ's may be changed to optimize the scores of alternative hypotheses in such a way that for each audio signal, the hypothesis closest to a reference transcription is sorted to the top of a list. A table of optimal context specific γ values for each context (sequence of previously recognized words) is the goal of the training phase and is discussed in greater detail in FIG. 2. Thus, in the training phase, the application 170 may be configured to compare the recognition results 114 of the recognized training audio 122 to a previously made transcription (e.g., the training audio transcriptions 112) of the training audio 122. In some embodiments, the training audio transcriptions 112 may comprise one or more manual transcriptions of the training audio 122. The application 170 may then be utilized to generate the context specific scale factors 110 (for replacing the static scale factors 108) based on the aforementioned optimization.

It should be understood that in the application phase, the optimized context-specific scale factors may then be utilized to recognize previously unseen audio. In this phase, no reference transcriptions are utilized, just audio signals. It should be further understood that learned context-specific scale factors may be applied in a number of ways. For example, the context-specific scale factors may be used directly during recognition or, alternatively, the audio signals may be recognized with a static γ, a list of alternative hypotheses may be obtained, and then the fixed γ may be replaced at every word by a context-specific version γ (i.e., the word's context). The use of the context-specific γ results in a change of scores for all of the hypotheses and the best hypothesis (i.e., the hypothesis having the highest score) may then be utilized. The application phase is discussed in greater detail below with respect to FIG. 3.

FIG. 2 is a block diagram illustrating a system 200 which may be utilized for generating the context specific scale factors 110 for use in a training phase in the system 100 of FIG. 1, in accordance with an embodiment. It should be understood that during training, a corpus of paired recognition results and corresponding manual transcriptions may be used to optimize context-specific language model scale factors with respect to a maximum score for a correct hypotheses. In the system 200, a comparison may be made (i.e., by the application 170) between the recognition results 114 from the training audio 122 and the training audio transcriptions 112. The recognition results 114 may include the hypotheses 115 which were produced by recognizing the training audio 122. Following the aforementioned comparison, a table 205 of context specific scale factors may be generated.

FIG. 3 is a block diagram illustrating a system 300 which may be utilized for utilizing the context specific scale factors 110 in an application phase in the system 100 of FIG. 1, in accordance with an embodiment. In the application phase, the context specific scale factors from the table 205 may be applied to hypotheses for non-training audio recognition 310 (i.e., for rescoring) or be directly applied to the non-training audio 124 (i.e., audio signals). It should be understood that the non-training audio 124 (or audio signals) represents previously unseen audio with respect to the system 100. That is, the non-training audio 124 is not based on a previous transcription. It should be further understood that during application, the table 205 may be used to directly optimize recognition or in a second pass to rescore recognition hypotheses.

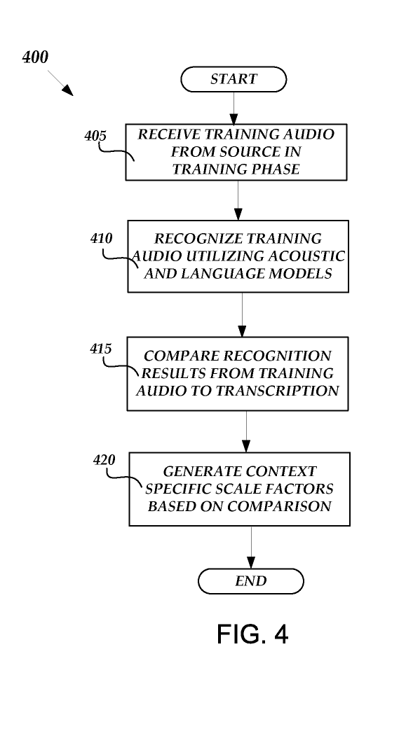

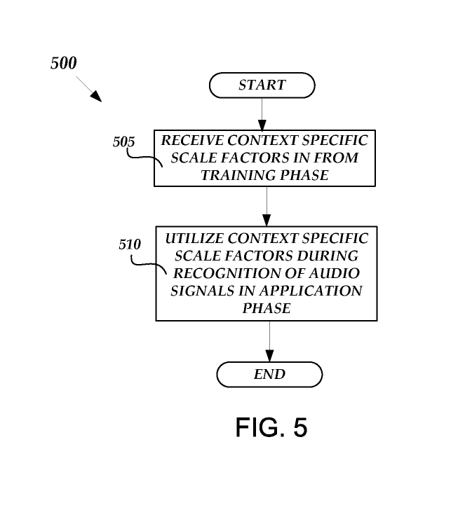

FIG. 4 is a flow diagram illustrating a routine 400 for generating context specific scale factors for use in a training phase of a speech recognition system, in accordance with an embodiment. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIGS. 4-5 and making up the various embodiments described herein are referred to variously as operations, structural devices, acts or modules. It will be recognized by one skilled in the art that these operations, structural devices, acts and modules may be implemented in software, in hardware, in firmware, in special purpose digital logic, and any combination thereof without deviating from the spirit and scope of the present invention as recited within the claims set forth herein.

The routine 400 begins at operation 405, where the application 170 executing on the computing device 150 may receive the training audio 122 from the source 120.

From operation 405, the routine 400 continues to operation 410, where the application 170 executing on the computing device 150 may recognize the received training audio 122 utilizing the acoustic and language models 104 and 106, respectively. As discussed above, the acoustic and language models 104 and 106 may be combined utilizing the static scale factors 108.

From operation 410, the routine 400 continues to operation 415, where the application 170 executing on the computing device 150 may compare the recognition results 114 from the received training audio 122 to a training audio transcription 112. As discussed above, the recognition results 114 may include one or more hypotheses for recognizing speech.

From operation 415, the routine 400 continues to operation 420, where the application 170 executing on the computing device 150 may generate the context specific scale factors in the table 205 (see FIG. 2) based on the comparison of the recognition results 114 and the training audio transcription 112. In particular, the context specific scale factors in the table 205 may be generated by inspecting one or more weighted combinations of acoustic model scores and language model scores in the produced hypotheses 115 and replacing default language model scale factors (i.e., the static scale factors 108) with the context specific scale factors in the table 205. It should be understood by those skilled in the art that a number of inequalities may be constructed that guarantee that the hypotheses with the lowest Word Error Rate (WER) among produced hypotheses receive the higher scores in pair-wise comparisons. For example, an audio signal may have K alternative recognition hypotheses and corresponding scores Sₖ as defined under argmax of the second formula discussed above with respect to FIG. 1. It should be understood that with respect to the aforementioned formula, P represents a probability, (aᵢ|wᵢ) represents the acoustic evidence of a particular word (acoustic model), wᵢ₋₁ . . . wᵢ₋ₙ₊₁ represents a history of previous recognitions for a word, (wᵢ|wᵢ₋₁ . . . wᵢ₋ₙ₊₁) represents word occurrence in context (language model), and γ represents a scale factor which could depend on its n-gram context in a recognized prefix for each word. With respect to the aforementioned formula, assuming k* is the hypothesis with the lowest WER, K−1 inequalities may be created requiring Sₖ<S_{k*} or variations thereof. Alternatively, K*(K−1)/2 inequalities may be created to assure a full ranking order on the hypothesis. Those skilled in the art should appreciate that constrained or unconstrained optimization may be utilized to estimate the context specific scale factors. For example, the aforementioned inequalities may be either turned into a soft-constrained optimization problem (thereby maximizing cumulative margins of all inequalities) in which case a linear optimization problem is presented that may be solved via a simplex method or other linear programming algorithms. Moreover, it should be understood that the aforementioned inequalities may be solved with respect to optimal context specific scale factors for each of one or more contexts. Alternatively or in addition to the aforementioned example, a regularization metric may be added to an objective function to maintain context specific scale factors as small as possible (i.e., maintain the context specific scale factors at a predetermined size). From operation 420, the routine 400 then ends.

FIG. 5 is a flow diagram illustrating a routine 500 for recognizing speech utilizing context-specific language model scale factors in an application phase of a speech recognition system, in accordance with an embodiment. The routine 500 begins at operation 505, where the application 170 executing on the computing device 150 may receive the context specific scale factors from the table 205 generated during the training phase described above with respect to FIG. 4.

From operation 505, the routine 500 continues to operation 510, where the application 170 executing on the computing device 150 may utilize the aforementioned context specific scale factors during the recognition of audio signals (i.e., the non-training audio 124) in a speech recognition application phase. In particular, the application 170 executing on the computing device 150 may apply the context specific scale factors for use in one or more speech recognition applications. For example, in some embodiments, the context specific scale factors may be utilized during speech recognition of the non-training audio 124 (i.e., previously unseen audio signals) received from the source 120. It should be understood that in applying the context specific scale factors, the application 170 may determine an absence of one or more context specific scale factors for a particular speech context and fall back to an associated speech sub-context. In particular, if a context specific scale factor has not been estimated for a particular context, the application 170 may suggest an incremental fall back on to shorter sub-contexts of the particular context. It should be further understood that the application 170, after applying the fixed scale factors, may select one or more hypotheses having the highest assigned acoustic model scores and language model scores and then assign new scores to these hypotheses using new context specific scale factors. In particular, the n-best recognition hypotheses may be rescored using new context-specific scale factors and the highest scoring hypotheses may then be selected. From operation 510, the routine 500 then ends.

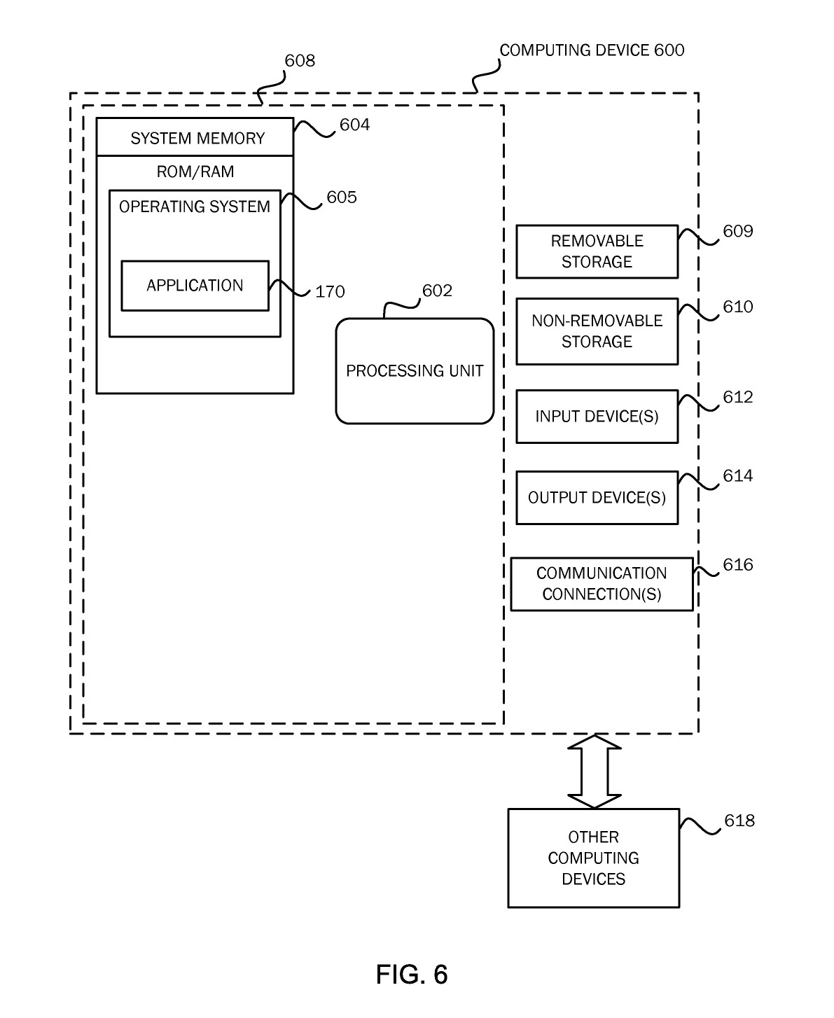

FIG. 6-8 and the associated descriptions provide a discussion of a variety of operating environments in which embodiments of the invention may be practiced. However, the devices and systems illustrated and discussed with respect to FIGS. 6-8 are for purposes of example and illustration and are not limiting of a vast number of computing device configurations that may be utilized for practicing embodiments of the invention, described herein.

FIG. 6 is a block diagram illustrating example physical components of a computing device 600 with which various embodiments may be practiced. In a basic configuration, the computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination. System memory 604 may include an operating system 605 and application 170. Operating system 605, for example, may be suitable for controlling the computing device 600's operation and, in accordance with an embodiment, may comprise the WINDOWS operating systems from MICROSOFT CORPORATION of Redmond, Wash. The application 170 (which, in some embodiments, may be included in the operating system 605) may comprise functionality for performing routines including, for example, the above-described routines 400-500 of FIGS. 4-5.

The computing device 600 may have additional features or functionality. For example, the computing device 600 may also include additional data storage devices (removable and/or non-removable) such as, for example, magnetic disks, optical disks, solid state storage devices (“SSD”), flash memory or tape. Such additional storage is illustrated in FIG. 6 by a removable storage 609 and a non-removable storage 610. The computing device 600 may also have input device(s) 612 such as a keyboard, a mouse, a pen, a sound input device (e.g., a microphone), a touch input device for receiving gestures, an accelerometer or rotational sensor, etc. Output device(s) 614 such as a display, speakers, a printer, etc. may also be included. The aforementioned devices are examples and others may be used. The computing device 600 may include one or more communication connections 616 allowing communications with other computing devices 618. Examples of suitable communication connections 616 include, but are not limited to, RF transmitter, receiver, and/or transceiver circuitry; universal serial bus (USB), parallel, and/or serial ports.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may operate via application-specific logic integrated with other components of the computing device/system 600 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

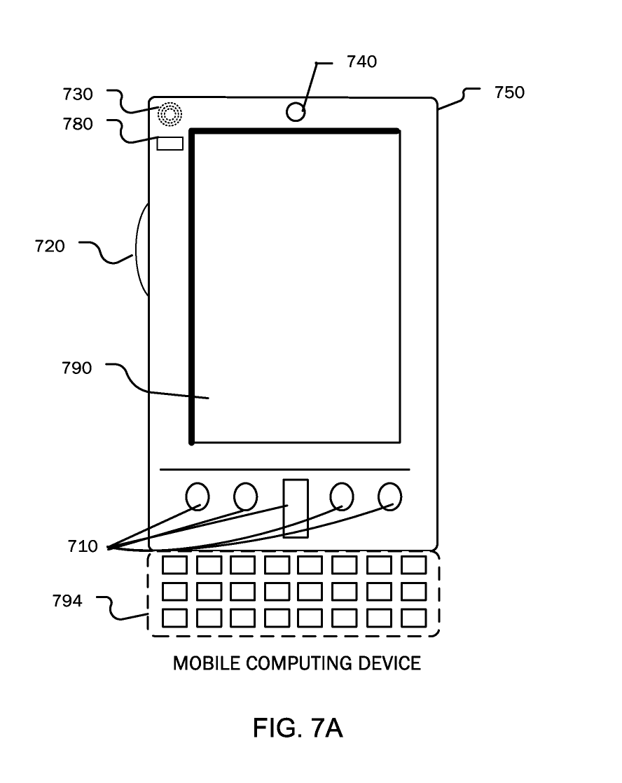

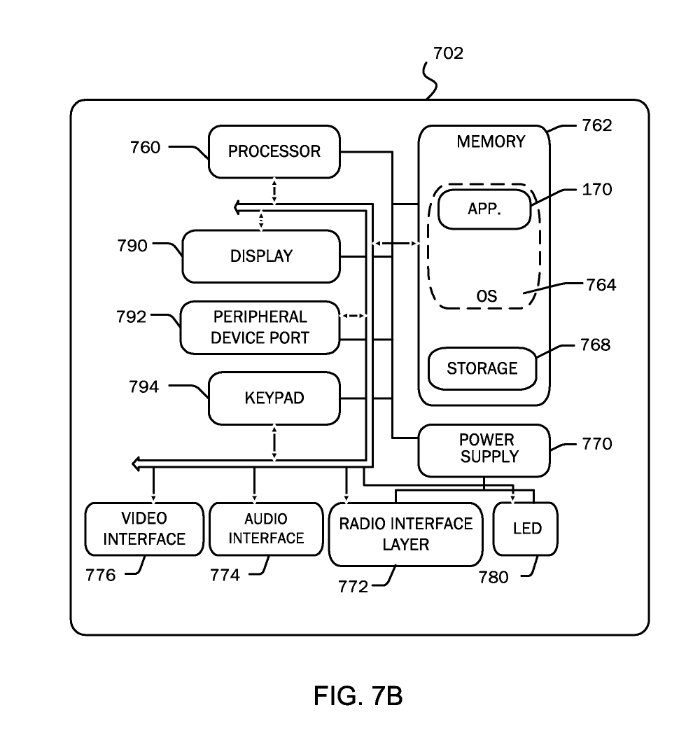

FIGS. 7A and 7B illustrate a suitable mobile computing environment, for example, a mobile computing device 750 which may include, without limitation, a smartphone, a tablet personal computer, a laptop computer and the like, with which various embodiments may be practiced. With reference to FIG. 7A, an example mobile computing device 750 for implementing the embodiments is illustrated. In a basic configuration, mobile computing device 750 is a handheld computer having both input elements and output elements. Input elements may include touch screen display 725 and input buttons 710 that allow the user to enter information into mobile computing device 750. Mobile computing device 750 may also incorporate an optional side input element 720 allowing further user input. Optional side input element 720 may be a rotary switch, a button, or any other type of manual input element. In alternative embodiments, mobile computing device 750 may incorporate more or less input elements. In yet another alternative embodiment, the mobile computing device is a portable telephone system, such as a cellular phone having display 725 and input buttons 710. Mobile computing device 750 may also include an optional keypad 705. Optional keypad 705 may be a physical keypad or a “soft” keypad generated on the touch screen display.

Mobile computing device 750 incorporates output elements, such as display 725, which can display a graphical user interface (GUI). Other output elements include speaker 730 and LED 780. Additionally, mobile computing device 750 may incorporate a vibration module (not shown), which causes mobile computing device 750 to vibrate to notify the user of an event. In yet another embodiment, mobile computing device 750 may incorporate a headphone jack (not shown) for providing another means of providing output signals.

Although described herein in combination with mobile computing device 750, in alternative embodiments may be used in combination with any number of computer systems, such as in desktop environments, laptop or notebook computer systems, multiprocessor systems, micro-processor based or programmable consumer electronics, network PCs, mini computers, main frame computers and the like. Various embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate the various embodiments described herein.

FIG. 7B is a block diagram illustrating components of a mobile computing device used in one embodiment, such as the mobile computing device 750 shown in FIG. 7A. That is, mobile computing device 750 can incorporate a system 702 to implement some embodiments. For example, system 702 can be used in implementing a “smartphone” that can run one or more applications similar to those of a desktop or notebook computer. In some embodiments, the system 702 is integrated as a computing device, such as an integrated personal digital assistant (PDA) and wireless phone.

Application 170 may be loaded into memory 762 and run on or in association with an operating system 764. The system 702 also includes non-volatile storage 768 within memory the 762. Non-volatile storage 768 may be used to store persistent information that should not be lost if system 702 is powered down. The application 170 may use and store information in the non-volatile storage 768. The application 170 may comprise functionality for performing routines including, for example, the above-described routines 400-500 of FIGS. 4-5.

A synchronization application (not shown) also resides on system 702 and is programmed to interact with a corresponding synchronization application resident on a host computer to keep the information stored in the non-volatile storage 768 synchronized with corresponding information stored at the host computer. As should be appreciated, other applications may also be loaded into the memory 762 and run on the mobile computing device 750.

The system 702 has a power supply 770, which may be implemented as one or more batteries. The power supply 770 might further include an external power source, such as an AC adapter or a powered docking cradle that supplements or recharges the batteries.

The system 702 may also include a radio 772 (i.e., radio interface layer) that performs the function of transmitting and receiving radio frequency communications. The radio 772 facilitates wireless connectivity between the system 702 and the “outside world,” via a communications carrier or service provider. Transmissions to and from the radio 772 are conducted under control of OS 764. In other words, communications received by the radio 772 may be disseminated to the application 170 via OS 764, and vice versa.

The radio 772 allows the system 702 to communicate with other computing devices, such as over a network. The radio 772 is one example of communication media. The embodiment of the system 702 is shown with two types of notification output devices: the LED 780 that can be used to provide visual notifications and an audio interface 774 that can be used with speaker 730 to provide audio notifications. These devices may be directly coupled to the power supply 770 so that when activated, they remain on for a duration dictated by the notification mechanism even though processor 760 and other components might shut down for conserving battery power. The LED 780 may be programmed to remain on indefinitely until the user takes action to indicate the powered-on status of the device. The audio interface 774 is used to provide audible signals to and receive audible signals from the user. For example, in addition to being coupled to speaker 730, the audio interface 774 may also be coupled to a microphone (not shown) to receive audible (e.g., voice) input, such as to facilitate a telephone conversation. In accordance with embodiments, the microphone may also serve as an audio sensor to facilitate control of notifications. The system 702 may further include a video interface 776 that enables an operation of on-board camera 740 to record still images, video streams, and the like.

A mobile computing device implementing the system 702 may have additional features or functionality. For example, the device may also include additional data storage devices (removable and/or non-removable) such as, magnetic disks, optical disks, or tape. Such additional storage is illustrated in FIG. 7B by storage 768.

Data/information generated or captured by the mobile computing device 750 and stored via the system 702 may be stored locally on the mobile computing device 750, as described above, or the data may be stored on any number of storage media that may be accessed by the device via the radio 772 or via a wired connection between the mobile computing device 750 and a separate computing device associated with the mobile computing device 750, for example, a server computer in a distributed computing network such as the Internet. As should be appreciated such data/information may be accessed via the mobile computing device 750 via the radio 772 or via a distributed computing network. Similarly, such data/information may be readily transferred between computing devices for storage and use according to well-known data/information transfer and storage means, including electronic mail and collaborative data/information sharing systems.

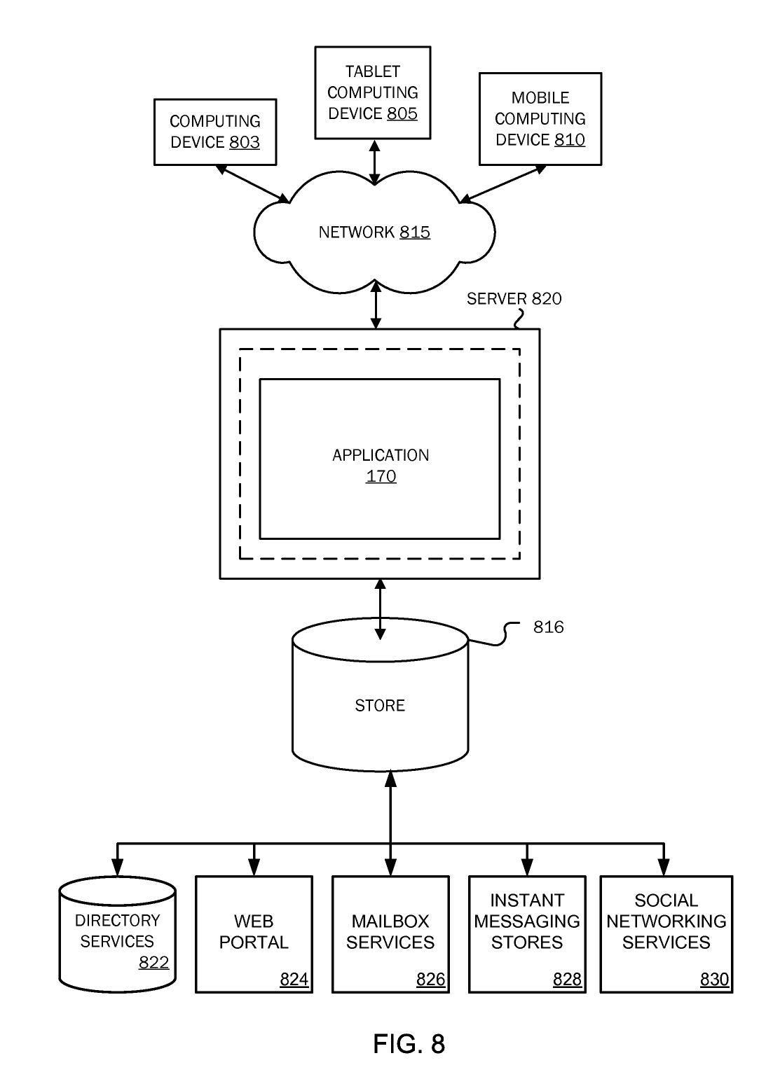

FIG. 8 is a simplified block diagram of a distributed computing system in which various embodiments may be practiced. The distributed computing system may include number of client devices such as a computing device 803, a tablet computing device 805 and a mobile computing device 810. The client devices 803, 805 and 810 may be in communication with a distributed computing network 815 (e.g., the Internet). A server 820 is in communication with the client devices 803, 805 and 810 over the network 815. The server 820 may store application 170 for performing routines including, for example, the above-described routines 400-500 of FIGS. 4-5.

Content developed, interacted with, or edited in association with the application 170 may be stored in different communication channels or other storage types. For example, various documents may be stored using a directory service 822, a web portal 824, a mailbox service 826, an instant messaging store 828, or a social networking site 830. The application 170 may use any of these types of systems or the like for enabling data utilization, as described herein. The server 820 may provide the proximity application 170 to clients. As one example, the server 820 may be a web server providing the application 170 over the web. The server 820 may provide the application 170 over the web to clients through the network 815. By way of example, the computing device 10 may be implemented as the computing device 803 and embodied in a personal computer, the tablet computing device 805 and/or the mobile computing device 810 (e.g., a smart phone). Any of these embodiments of the computing devices 803, 805 and 810 may obtain content from the store 816.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method of recognizing speech utilizing context-specific language model scale factors, comprising:
receiving, by a computing device, training audio from a source in a training phase;
recognizing, by the computing device, the received training audio utilizing an acoustic model and a language model, the acoustic model and the language model being combined utilizing static scale factors;
comparing, by the computing device, a plurality of recognition results from the received training audio to a transcription of the training audio, the plurality of recognition results comprising one or more hypotheses;
generating, by the computing device, context specific scale factors based on the comparison of the plurality of recognition results and the transcription; and
applying, by the computing device, the context specific scale factors for use in one or more speech recognition applications in an application phase.

2. The method of claim 1, wherein generating, by the computing device, context specific scale factors based on the comparison of the plurality of recognition results and the transcription comprises:
inspecting one or more weighted combinations of acoustic model scores and language model scores in the one or more hypotheses;
replacing the applied static scale factors with the context specific scale factors based on the inspection of the one or more weighed combinations;
constructing one or more inequalities to assign higher acoustic model scores and language model scores to one or more of the hypotheses having a low word error rate; and
solving the one or more inequalities with respect to optimal context specific scale factors for each of one or more contexts.

3. The method of claim 2, further comprising:
utilizing at least one of unconstrained optimization and constrained optimization to estimate the context specific scale factors; and
adding a metric to maintain the context specific scale factors at a predetermined size when utilizing the constrained optimization.

4. The method of claim 1, wherein applying, by the computing device, the context specific scale factors for use in one or more speech recognition applications in an application phase comprises utilizing the context specific scale factors during speech recognition of non-training audio received from the source.

5. The method of claim 1, wherein applying, by the computing device, the context specific scale factors for use in one or more speech recognition applications in an application phase comprises determining an absence of at least one of the context specific scale factors for a particular speech context.

6. The method of claim 5, further comprising falling back to a sub-context of the particular speech context, the sub-context being associated with one of the context specific scale factors.

7. The method of claim 2, wherein applying, by the computing device, the context specific scale factors for use in one or more speech recognition applications in an application phase comprises:
selecting the one or more of hypotheses having the highest assigned acoustic model scores and language model scores; and
assigning new scores to the one or more hypotheses using new context specific scale factors.

8. A system for recognizing speech utilizing context-specific language model scale factors, comprising:
a memory for storing executable program code; and
a processor, functionally coupled to the memory, the processor being responsive to computer-executable instructions contained in the program code and operative to:
receive training audio from a source in a training phase;
recognize the received training audio utilizing an acoustic model and a language model, the acoustic model and the language model having applied static scale factors;
compare a plurality of recognition results from the received training audio to a transcription of the training audio, the plurality of recognition results comprising one or more hypotheses;
generate context specific scale factors based on the comparison of the plurality of recognition results and the transcription; and
apply the context specific scale factors for use in one or more speech recognition applications in an application phase.

9. The system of claim 8, wherein the processor, in generating context specific scale factors based on the comparison of the plurality of recognition results and the transcription, is operative to:
inspect one or more weighted combinations of acoustic model scores and language model scores in the one or more hypotheses;
replace the applied static scale factors with the context specific scale factors based on the inspection of the one or more weighed combinations; and
construct one or more inequalities to assign higher acoustic model scores and language model scores to the one or more hypotheses having a low word error rate; and
solve the one or more inequalities with respect to optimal context specific scale factors for each of one or more contexts.

10. The system of claim 9, wherein the processor is further operative to:
utilize at least one of unconstrained optimization and constrained optimization to estimate the context specific scale factors; and
add a metric to maintain the context specific scale factors at a predetermined size when utilizing the constrained optimization.

11. The system of claim 8, wherein the processor, in applying the context specific scale factors for use in one or more speech recognition applications in an application phase, is operative to utilize the context specific scale factors during speech recognition of non-training audio received from the source.

12. The system of claim 8, wherein the processor, in applying the context specific scale factors for use in one or more speech recognition applications in an application phase, is operative to determine an absence of at least one of the context specific scale factors for a particular speech context.

13. The system of claim 12, wherein the processor is further operative to fall back to a sub-context of the particular speech context, the sub-context being associated with one of the context specific scale factors.

14. The system of claim 8, wherein the processor, in applying the context specific scale factors for use in one or more speech recognition applications in an application phase, is operative to:
select one or more of the hypotheses having the highest assigned acoustic model scores and language model scores; and
assign new scores to the one or more hypotheses using new context specific scale factors.

15. A computer-readable storage medium storing computer executable instructions which, when executed by a computer, will cause computer to perform a method of recognizing speech utilizing context-specific language model scale factors, comprising:
receiving training audio from a source in a training phase;
recognizing the received training audio utilizing an acoustic model and a language model, the acoustic model and the language model being combined utilizing static scale factors;
comparing a plurality of recognition results from the received training audio to a transcription of the training audio, the plurality of recognition results comprising one or more hypotheses;
generating context specific scale factors based on the comparison of the plurality of recognition results and the transcription by:
inspecting one or more weighted combinations of acoustic model scores and language model scores in the one or more hypotheses;
replacing the applied static scale factors with the context specific scale factors based on the inspection of the one or more weighed combinations; and
constructing one or more inequalities to assign higher acoustic model scores and language model scores to the one or more hypotheses having a low word error rate;
solving the one or more inequalities with respect to optimal context specific scale factors for each of one or more contexts; and
applying the context specific scale factors for use in one or more speech recognition applications in an application phase.

16. The computer-readable storage medium of claim 15, wherein generating context specific scale factors based on the comparison of the plurality of recognition results and the transcription further comprises:
utilizing at least one of unconstrained optimization and constrained optimization to estimate the context specific scale factors; and
adding a metric to maintain the context specific scale factors at a predetermined size when utilizing the constrained optimization.

17. The computer-readable storage medium of claim 15, wherein applying the context specific scale factors for use in one or more speech recognition applications in an application phase, comprises utilizing the context specific scale factors during speech recognition of non-training audio received from the source.

18. The computer-readable storage medium of claim 15, wherein applying the context specific scale factors for use in one or more speech recognition applications in an application phase comprises determining an absence of at least one of the context specific scale factors for a particular speech context.

19. The computer-readable storage medium of claim 15, further comprising falling back to a sub-context of the particular speech context, the sub-context being associated with one of the context specific scale factors.

20. The computer-readable storage medium of claim 15, wherein applying the context specific scale factors for use in one or more speech recognition applications in an application phase comprises:
selecting the one or more hypotheses having the highest assigned acoustic model scores and language model scores; and
assigning new scores to the one or more hypotheses using new context specific scale factors.
